(19) United States
(12) Patent Application Publication
(10) Pub. No.: US 2023/0174720 A1
(43) Pub. Date: Jun. 8, 2023

(54) POLY(ARYLENE SULFIDE) COPOLYMER

(71) Applicant: SOLVAY SPECIALTY POLYMERS USA, LLC, Alpharetta, GA (US)

(72) Inventors: Kelly D. Branham, Woodstock, GA (US); Ryan Mondschein, Cumming, GA (US); Joel Pollino, Johns Creek, GA (US); Stéphane Jeol, Saint-Genis-Laval (FR); Lee Carvell, Cumming, GA (US); William E. Sattich, Cumming, GA (US)

(73) Assignee: SOLVAY SPECIALTY POLYMERS USA, LLC, Alpharetta, GA (US)

(21) Appl. No.: 17/998,109

(22) PCT Filed: May 4, 2021
(86) PCT No.: PCT/EP2021/061639

§ 371 Date: Nov. 7, 2022

Related U.S. Application Data
(60) Provisional application No. 63/021,102, filed on May 7, 2020.

(30) Foreign Application Priority Data
Aug. 3, 2020 (EP) 20189253.6

(51) Int. Cl. C08G 75/0245; C08G 77/14; C08G 77/38

(52) U.S. Cl. CPC C08G 75/0245; C08G 77/14; C08G 77/38; B33Y 10/00

(57) ABSTRACT

The present invention relates to a poly(arylene sulfide) (PAS) copolymer (P) comprising: at least one block of poly(arylene sulfide) (PAS) having a weight-average molecular weight (Mw) of at least 40,000 g/mol as determined by gel permeation chromatography, and at least one block of polyorganosiloxane (POS) having a weight-average molecular weight (Mw) of at most 5,000 g/mol as determined by gel permeation chromatography, wherein the weight ratio of PAS:POS is from 95:5 to 99.5:0.5.

### TECHNICAL FIELD

The present invention relates to a poly(arylene sulfide) copolymer, to a process for its manufacturing and to a composition comprising this copolymer, as well as to an article, part or composite material comprising this copolymer or this composition, and to the use of this copolymer or this composition for the manufacture of 3D objects.

### BACKGROUND ART

Poly(arylene sulfide) (PAS) polymers are semi-crystalline thermoplastic polymers having notable mechanical properties, such as high tensile modulus and high tensile strength, and remarkable stability towards thermal degradation and chemical reactivity. They are also characterized by excellent melt processing, such as injection molding.

This broad range of properties makes PAS polymers suitable for a large number of applications, for example in the automotive, electrical, electronic, aerospace and appliances markets.

Despite the above advantages, PAS polymers are known to present a low impact resistance and a low elongation at break, in other words a poor ductility and a poor toughness.

Several prior art documents describe the preparation of compatible blends of poly(arylene sulphide) polymers and epoxy-functionalized siloxane polymers. For example, U.S. Pat. No. 5,324,796 describes compositions comprising poly(phenylene sulphide) polymers blended with high molecular weight epoxy-functionalized siloxane polymers (having a molecular weight higher than 5,000 g/mol), wherein the weight ratio between the siloxane and poly(phenylene sulfide) polymers is 0.1-25:100 and wherein the poly(phenylene sulfide) polymers are branched by heat curing in an oxidative atmosphere.

Other prior art documents describe the modification of the main chain skeleton of the PAS polymer by chemically bonding the poly(arylene sulfide) to a polyorganosiloxane into a copolymer. For example, U.S. Pat. No. 9,840,596 describes a poly(phenylene sulfide) block copolymer containing poly(phenylene sulfide) units of low weight-average molecular weight and polyorganosiloxane units.

The present invention relates to a copolymer (P) comprising at least one block of poly(arylene sulfide) (PAS) of high weight-average molecular weight (Mw) (i.e. Mw of at least 40,000 g/mol as determined by gel permeation chromatography) and at least one block of polyorganosiloxane (POS) of low weight-average molecular weight (Mw) (i.e. Mw of at most 5,000 g/mol as determined by gel permeation chromatography), which presents improved elongation at break over the copolymer described in the prior art. This makes the copolymer (P) of the present invention well suited for applications requiring high tensile strength, ductile and tough polymeric materials.

### SUMMARY OF INVENTION

In a first aspect, the present invention relates to a poly(arylene sulfide) copolymer (P) comprising:
at least one block of poly(arylene sulfide) (PAS) having a weight-average molecular weight (Mw) of at least 40,000 g/mol as determined by gel permeation chromatography, and
at least one block of polyorganosiloxane (POS) having a weight-average molecular weight (Mw) of at most 5,000 g/mol as determined by gel permeation chromatography,

wherein the weight ratio of PAS:POS is from 95:5 to 99.5:0.5.

In a second aspect, the present invention relates to a process for preparing a poly(arylene sulfide) (PAS) copolymer (P) comprising blending at a temperature of at least Tₘ+10° C. a reaction mixture comprising:
at least one poly(arylene sulfide) (PAS) polymer having a weight-average molecular weight (Mw) of at least 40,000 g/mol as determined by gel permeation chromatography, and
at least one polyorganosiloxane (POS) macromer having epoxy groups at each end of its chain and having a weight-average molecular weight (Mw) of at most 5,000 g/mol as determined by gel permeation chromatography,

wherein:
Tₘ is the melting point of the reaction mixture,
the weight ratio between the PAS polymer and the POS macromer is from 95:5 to 99.5:0.5, and
the process is carried out in the absence of added solvent or in the presence of an amount of added solvent less than 2 wt. %, based on the total weight of the reaction mixture.

In a third aspect, the present invention relates to a composition (C) comprising:
the poly(arylene sulfide) (PAS) copolymer (P) described above, and
up to 60 wt. %, based on the total weight of the composition (C), of at least one filler.

In a forth aspect, the present invention relates to an article, part or composite material comprising the PAS copolymer (P) or the composition (C) as defined above, for example a cable coating, a cable tie, a metal pipe coating, a molded article, an extruded article or a three-dimensional (3D) object.

In a fifth aspect, the present invention relates to the use of the PAS copolymer (P) or of the composition (C) as defined above for the manufacture of a three-dimensional (3D) object using additive manufacturing, preferably fused deposition modelling (FDM), selective laser sintering (SLS) or multi jet fusion (MJF).

Advantageously, the PAS copolymer (P) according to the present invention shows significantly improved impact resistance and elongation at break compared to poly(arylene sulfide) polymers which are not modified with polyorganosiloxane blocks, while maintaining high tensile strength.

### DISCLOSURE OF THE INVENTION

Described herein is a poly(arylene sulfide) (PAS) block copolymer (P) comprising one or more blocks of high molecular weight poly(arylene sulfide) (PAS) and one or more blocks of low molecular weight polyorganosiloxane (POS), wherein the weight ratio between the PAS block(s) and the POS block(s) ranges between 95:5 and 99.5:0.5. More specifically, the weight-average molecular weight (Mw) of one PAS block is of at least 40,000 g/mol as determined by gel permeation chromatography, and the weight-average molecular weight (Mw) of one POS block is of at most 5,000 g/mol as determined by gel permeation chromatography.

The introduction of a small amount (up to 5 wt. %) of low-molecular weight POS into the main chain of a high-molecular weight PAS provides a significant increase in the elongation at break of the PAS, with no or negligible decrease in the modulus of elasticity and tensile strength at yield, or even with a slight increase thereof. Accordingly, the POS-modified PAS according to the invention shows greater ductility and toughness than an unmodified PAS, while keeping substantially unaltered the strength and stiffness of the unmodified PAS.

Especially, it was found that, despite their higher molecular weight (i.e. their longer chains), that-is-to-say a lower concentration of reactive end-groups, the PAS blocks are reactive enough towards the POS blocks to prepare copolymers presenting improved impact resistance and elongation at break.

In the present application, any description, even though described in relation to a specific embodiment, is applicable to and interchangeable with other embodiments of the present disclosure.

In the present application, where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list.

In the present application, any recitation herein of numerical ranges by endpoints includes all numbers subsumed within the recited ranges as well as the endpoints of the range and equivalents.

Poly(Arylene Sulfide) (PAS) Copolymer (P)

The poly(arylene sulfide) (PAS) copolymer (P) of the invention is a block copolymer containing at least one block of poly(arylene sulfide) (PAS) having a weight-average molecular weight (Mw) of at least 40,000 g/mol as determined by gel permeation chromatography and at least one block of polyorganolsiloxane (POS) having a weight-average molecular weight of at most 5,000 g/mol as determined by gel permeation chromatography, wherein the weight ratio between PAS and POS ranges from 95:5 to 99.5:0.5.

The expression “block copolymer” as used herein is intended to denote a linear polymer comprising two or more polymer blocks linked together by covalent bonds. The union of the polymer blocks may require an intermediate non-repeating subunit, known as junction block. A “block” is a portion of a macromolecule, comprising many units, that has at least one feature which is not present in the adjacent portions. The definition of “block copolymer” excludes branched structures in which the branches are composed of blocks.

For the sake of brevity, the at least one block of poly(arylene sulfide) (PAS) is also referred to as PAS block(s), and the at least one block of polyorganosiloxane (POS) is also referred to as POS block(s).

Preferably, the PAS block comprises at least 50 mol. % of recurring units (R_{PAS}) according to formula (I), based on the total number of moles of recurring units in the PAS block:

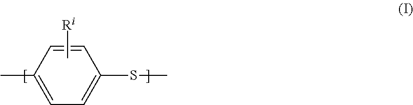

wherein:

R is independently selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and i is independently zero or an integer from 1 to 4.

According to formula (I), the aromatic cycle of the recurring unit (R_{PAS}) may contain from 1 to 4 radical groups R. In a preferred embodiment, i is zero in formula (I) and, accordingly, the corresponding aromatic cycle does not contain any radical group R.

According to different embodiments of the invention, the PAS block comprises at least 60 mol. %, at least 70 mol. %, at least 80 mol. %, at least 90 mol. %, at least 95 mol. % of recurring units (R_{PAS}) of formula (I), based on the total number of moles of recurring units in the PAS block.

According to an embodiment of the invention, the PAS block consists of, or consists essentially of, recurring units (R_{PAS}) of formula (I). The expression “consists essentially of” means that the PAS block comprises recurring (R_{PAS}) of formula (I) as well as less than 5 mol. %, preferably less than 3 mol. %, more preferably less than 1 mol. %, of other recurring units distinct from recurring units (R_{PAS}) of formula (I), based on the total number of moles of recurring units in the PAS block.

According to a preferred embodiment of the invention, the PAS block consists of recurring units (R_{PAS}) according to formula (I) wherein i is zero.

In some embodiments, the PAS block is linear or uncured.

Preferably, the PAS block has a weight-average molecular weight (Mw) of at least 45,000 g/mol, more preferably of at least 50,000 g/mol, even more preferably of at least 55,000 g/mol, as determined by gel permeation chromatography.

Preferably, the PAS block has a weight-average molecular weight (Mw) of at most 120,000 g/mol, more preferably of at most 110,000 g/mol, even more preferably of at most 100,000 g/mol, still more preferably of at most 90,000 g/mol, as determined by gel permeation chromatography.

Preferably, the PAS block is such that it exhibits, as a main technical feature, a calcium content of less than 200 ppm, as measured by X-ray Fluorescence (XRF) analysis calibrated with standards of known calcium content as determined by Inductively Coupled Plasma Optical Emission Spectrometry (ICP-OES) according to ASTM UOP714-07.

Preferably, the POS block complies with formula (II):

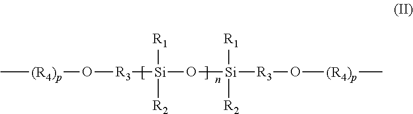

wherein:

R₁, R₂, R₃ and R₄, equal to or different from each other, are selected from C₁-C₁₀ aliphatic groups and C₆-C₁₀ aromatic groups,

n varies between 2 and 70, preferably between 2 and 60, and

p is zero or 1.

Preferably, R₁ and R₂, equal to or different from each other, represent an alkyl group such as methyl, ethyl, or propyl, or an aromatic group such as phenyl or naphthyl. Preferably, R₃ and R₄, equal to or different from each other, represent an alkylene group such as methylene, ethylene, or propylene, or an aromatic group such as phenylene.

According to a preferred embodiment, the POS block is a polydimethylsiloxane block, also referred to as PDMS block, wherein R₁ and R₂ are methyl groups, R₃ is a propylene group, p is 1 and R₄ is a methylene group. The PDMS block complies with formula (III):

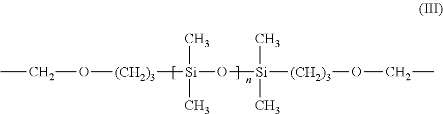

The POS block is preferably free from nitrogen atoms.

According to different embodiments of the invention, the POS block has a weight-average molecular weight of at most 5,000 g/mol, at most 4,800 g/mol, at most 4,500 g/mol, at most 4,000 g/mol, at most 3,000 g/mol, at most 2,000 g/mol, at most 1,200 g/mol, as determined by gel permeation chromatography.

According to different embodiments of the invention, the POS block has a weight-average molecular weight of at least 200 g/mol, at least 300 g/mol, at least 400 g/mol, at least 500 g/mol, as determined by gel permeation chromatography.

According to different embodiments of the invention, the content of the POS block(s) in the PAS copolymer (P) is at least 0.5 wt. %, at least 1.2 wt. %, at least 1.6 wt. %, at least 2.5 wt. %, based on the total weight of the PAS block(s) and the POS block(s).

According to different embodiments of the invention, the content of the POS block(s) in the PAS copolymer (P) is at most 5.0 wt. %, at most 4.8 wt. %, at most 4.0 wt. %, at most 3.5 wt. %, based on the total weight of the PAS block(s) and the POS block(s).

According to different embodiments of the invention, the weight ratio between the PAS block(s) and the POS block(s) ranges from 95:5 to 99.5:0.5, from 95.2:4.8 to 98.8:1.2, from 96:4 to 98.4:1.6, from 96.5:3.5 to 97.5:2.5.

In some embodiments, the PAS copolymer (P) of the present invention preferably has at least 1 ppm (wt) content of polymer-bonded chlorine, based on the total weight of the PAS copolymer (P), for example at least 100 ppm (wt) or at least 200 ppm (wt) or at least 300 ppm (wt).

In some embodiments, the PAS copolymer (P) of the present invention preferably has not more than 2,000 ppm (wt) content of polymer-bonded chlorine, based on the total weight of the PAS copolymer (P), for example not more than 1,800 ppm (wt) or not more than 1,500 ppm (wt) or not more than 1,200 ppm (wt).

In some embodiments, the PAS copolymer (P) of the present invention has a content of polymer-bonded chlorine ranging from 1 to 2,000 ppm (wt), based on the total weight of the PAS copolymer (P), for example ranging from 100 to 1,800 ppm (wt) or ranging from 200 to 1,500 ppm (wt) or ranging from 300 to 1,200 ppm (wt).

The content of polymer-bonded chlorine that can be obtained corresponds to the content of chloro end groups and for the purposes of the present invention it is determined by means of X-ray Fluoroscence (XRF) analysis calibrated with standards of known chlorine content as determined via Combustion and Ion Chromatography according to BS EN 14582.

Preferably, the PAS copolymer (P) has a melting point (Tₘ) of at least 230° C., more preferably of at least 250° C., even more preferably of at least 260° C., when determined on the 2^{nd} heat scan in differential scanning calorimeter (DSC) according to ASTM D3418, using heating and cooling rates of 20° C./min.

Preferably, the PAS copolymer (P) has a melting point (Tₘ) of at most 300° C., more preferably of at most 295° C., even more preferably of at most 290° C., when determined on the 2^{nd} heat scan in differential scanning calorimeter (DSC) according to ASTM D3418, using heating and cooling rates of 20° C./min.

Preferably, the PAS copolymer (P) has a glass transition temperature (T_{g}) of at least 50° C., more preferably of at least 70° C., even more preferably of at least 80° C., when determined on the 2^{nd} heat scan in differential scanning calorimeter (DSC) according to ASTM D3418, using heating and cooling rates of 20° C./min.

Preferably, the PAS copolymer (P) has a glass transition temperature (T_{g}) of at most 180° C., more preferably of at most 150° C., even more preferably of at most 130° C., when determined on the 2^{nd} heat scan in differential scanning calorimeter (DSC) according to ASTM D3418, using heating and cooling rates of 20° C./min.

Preferably, the PAS copolymer (P) has a weight-average molecular weight (Mw) ranging from 40,000 g/mol to 120,000 g/mol, more preferably from 45,000 g/mol to 100,000 g/mol, even more preferably from 50,000 g/mol to 80,000 g/mol, as determined by gel permeation chromatography.

Process for Preparing the PAS Copolymer (P)

Another object of the present invention is a process for preparing the poly(arylene sulfide) (PAS) copolymer (P) described above. This process comprises blending at a temperature of at least Tₘ+10° C. a reaction mixture comprising:
at least one poly(arylene sulfide) (PAS) polymer having a weight-average molecular weight (Mw) of at least 40,000 g/mol as determined by gel permeation chromatography, and
at least one polyorganosiloxane (POS) macromer having epoxy groups at each end of its chain and having a weight-average molecular weight (Mw) of at most 5,000 g/mol as determined by gel permeation chromatography,

wherein:
Tₘ is the melting point of the reaction mixture,
the weight ratio between the PAS polymer and the POS macromer is from 95:5 to 99.5:0.5, and
the process is carried out in the absence of added solvent or in the presence of an amount of added solvent less than 2 wt. %, based on the total weight of the reaction mixture.

As used herein, the term “macromer” is intended to denote any polymer or oligomer that has a functional group that can take part in further polymerization.

As used herein, the term “chain” is intended to denote the longest series of covalently bonded atoms that together create a continuous chain in a molecule.

When the process is carried out in the presence of added solvent, the solvent is preferably an organic amide solvent. Examples thereof include N-alkyl pyrrolidones, such as N-methyl-2-pyrrolidone, N-ethyl-2-pyrrolidone, and N-cyclohexyl-2-pyrrolidone, caprolactams, such as N-methyl-ε-caprolactam, 1,3-dimethyl-2-imidazolidinone, N,N-dimethylacetamide, N,N-dimethylformamide, hexamethylphosphoric triamide, diphenyl sulfone and mixtures thereof. Among these, N-methyl-2-pyrrolidone and 1,3-dimethyl-2-imidazolidinone are preferred, and N-methyl-2-pyrrolidone is more preferred.

The PAS polymer advantageously comprises at least one functional group at at least one of its chain ends. Preferably, the PAS polymer has functional groups at each end of its chain.

Preferably, the functional groups are according to formula (IV) below:

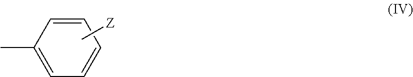

wherein Z is selected from the group consisting of halogen atoms (e.g. chlorine), carboxyl group, amino group, hydroxyl group, thiol group, acid anhydride group, isocyanate group, amide group, and derivatives thereof such as salts of sodium, lithium, potassium, calcium, magnesium, zinc.

Preferably, the functional groups are reactive and they are selected from the group consisting of carboxyl group, amino group, hydroxyl group, thiol group, acid anhydride group, isocyanate group, amide group, and derivatives thereof such as salts of sodium, lithium, potassium, calcium, magnesium, zinc.

Preferably, the functional groups are selected from the group consisting of hydroxyl group, thiol group, hydroxylate and thiolate.

Preferably, the PAS polymer is linear.

Preferably, the PAS polymer is linear and comprises at least one reactive functional group at at least one chain end. In an embodiment, the PAS polymer is linear and comprises at least one reactive functional group at each end of its chain.

Preferably, The PAS polymer comprises at least 50 mol. % of recurring units (R_{PAS}) according to formula (I) above, based on the total number of moles of recurring units in the PAS polymer.

According to different embodiments of the invention, the PAS polymer comprises at least 60 mol. %, at least 70 mol. %, at least 80 mol. %, at least 90 mol. %, at least 95 mol. % of recurring units (R_{PAS}) of formula (I), based on the total number of moles of recurring units in the PAS polymer.

According to an embodiment of the invention, the PAS polymer consists of, or consists essentially of, recurring units (R_{PAS}) of formula (I). The expression “consists essentially of” means that the PAS block comprises recurring (R_{PAS}) of formula (I) as well as less than 5 mol. %, preferably less than 3 mol. %, more preferably less than 1 mol. %, of other recurring units distinct from recurring units (R_{PAS}) of formula (I), based on the total number of moles of recurring units in the PAS block.

Preferably, the PAS polymer has a weight-average molecular weight (Mw) of at least 45,000 g/mol, more preferably of at least 50,000 g/mol, even more preferably of at least 55,000 g/mol, as determined by gel permeation chromatography.

Preferably, the PAS polymer has a weight-average molecular weight of at most 120,000 g/mol, more preferably of at most 110,000 g/mol, even more preferably of at most 100,000 g/mol, still more preferably of at most 90,000 g/mol, as determined by gel permeation chromatography.

Preferably, the PAS polymer has a melt flow rate (at 316° C. under a weight of 5 kg according to ASTM D1238, procedure B) of at most 400 g/10 min, more preferably of at most 300 g/10 min, even more preferably of at most 200 g/10 min.

Preferably, the PAS polymer has a melt flow rate (at 316° C. under a weight of 5 kg according to ASTM D1238, procedure B) of at least 30 g/10 min, more preferably of at least 50 g/10 min, even more preferably of at least 70 g/10 min.

Preferably, the PAS polymer is such that it exhibits, as a main technical feature, a calcium content of less than 200 ppm, as measured by X-ray Fluorescence (XRF) analysis calibrated with standards of known calcium content as determined by Inductively Coupled Plasma Optical Emission Spectrometry (ICP-OES) according to ASTM UOP714-07.

PAS polymers are commercially available as RYTON® PPS from Solvay Specialty Polymers USA, L.L.C.

Preferably, the POS macromer complies with formula (VI):

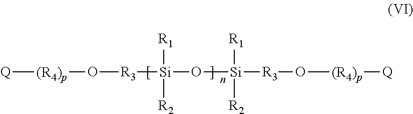

wherein:

Q is an epoxy group,

R₁, R₂, R₃ and R₄, equal to or different from each other, are selected from C₁-C₁₀ alkyl groups and C₆-C₁₀ aromatic groups,

n varies between 2 and 70, preferably between 2 and 60, and

p is zero or 1.

Preferably, R₁ and R₂, equal to or different from each other, represent an alkyl group such as methyl, ethyl, or propyl, or an aromatic group such as phenyl or naphthyl. Preferably, R₃ and R₄ are alkylene groups such as methylene, ethylene, or propylene, or aromatic groups such as phenylene.

According to a preferred embodiment, the POS macromer is a polydimethylsiloxane (PDMS) macromer, wherein R₁ and R₂ are methyl groups, R₃ is a propylene group, p is 1 and R₄ is a methylene group.

According to different embodiments, the POS macromer has a weight-average molecular weight (Mw) of at most 5,000 g/mol, at most 4,800 g/mol, at most 4,500 g/mol, at most 4,000 g/mol, at most 3,000 g/mol, at most 2,000 g/mol, at most 1,200 g/mol, as determined by gel permeation chromatography.

According to different embodiments, the POS macromer has a weight-average molecular weight (Mw) of at least 200 g/mol, at least 300 g/mol, at least 400 g/mol, at least 500 g/mol, as determined by gel permeation chromatography.

Preferably, the POS macromer is such that it does not contain any nitrogen atom.

For example, the copolymer (P) of the present invention can be obtained by “reactive extrusion” (also called REX). According to this embodiment, the reactive extrusion comprises several operations such as melting, compounding, homogenization and pumping of the reactive materials with simultaneous chemical reaction taking place inside the extruder. The reactive materials (PAS polymer and POS macromer) can be introduced at various points along the extruder. The extruder may consist in a horizontal reactor with one or several internal screws for conveying the reactive materials in the form of a solid or slurry, melt or liquid. The PAS polymer may be introduced into the extruder in the shape of powder, granules or pellets. The POS macromer may be introduced into the extruder in the shape of liquid, viscous liquid or powder. The absence of solvent is an advantage, as no solvent stripping or recovery process is required, and product contamination by solvent or solvent impurities is avoided.

Composition (C) and Method for its Manufacturing

As already said, the present invention also relates to a composition (C) comprising the poly(arylene sulfide) (PAS) copolymer (P) described above and at least one filler in an amount up to 60 wt. %, based on the total weight of the composition (C).

The composition may also comprise at least one additive, for example in an amount of less than 10 wt. %, said additive being selected from the group consisting of colorants, dyes, pigments, lubricants, plasticizers, flame retardants, nucleating agents, heat stabilizers, light stabilizers, antioxidants, processing aids, fusing agents, electromagnetic absorbers and combinations thereof, wherein the wt. % is based on the total weight of the composition (C).

According to various embodiments of the invention, said at least one filler is present in the composition (C) in an amount of at least 5 wt. %, at least 10 wt. %, at least 15 wt. %, at least 20 wt. %, based on the total weight of the composition (C).

According to various embodiments of the invention, said at least one filler is present in the composition (C) in an amount of at most 60 wt. %, at most 55 wt. %, at most 50 wt. %, at most 45 wt. %, based on the total weight of the polymer composition (C).

According to various embodiments of the invention, said at least one additional additive may be present in the composition (C) in an amount of less than 5 wt. %, less than 4 wt. %, less than 3 wt. %, less than 2 wt. %, less than 1 wt. %, based on the total weight of the composition (C).

Said at least one filler may be selected from the group consisting of toughening agents and reinforcing agents.

The toughening agents are preferably selected from elastomers. In a preferred embodiment, the toughening agents are present in the composition (C) in an amount up to 30 wt. %, for example up to 25 wt. %, based on the total weight of the composition (C).

The reinforcing agents may be selected from the group consisting of fibrous reinforcing fillers, particulate reinforcing fillers and mixtures thereof. A fibrous reinforcing filler is considered herein to be a material having length, width and thickness, wherein the average length is significantly larger than both the width and the thickness. Generally, a fibrous reinforcing filler has an aspect ratio, defined as the average ratio between the length and the largest of the width and the thickness of at least 5, at least 10, at least 20 or at least 50.

Fibrous reinforcing fillers include glass fibers, carbon or graphite fibers, and fibers formed of silicon carbide, alumina, titania, boron and the like, and may include mixtures comprising two or more such fibers. Non-fibrous reinforcing fillers include notably talc, mica, titanium dioxide, calcium carbonate, potassium titanate, silica, kaolin, chalk, alumina, mineral fillers, and the like.

Preferably, said at least one filler is a fibrous reinforcing filler. Among fibrous reinforcing fillers, glass fibers and carbon fibers are preferred. According to a preferred embodiment of the invention, said composition (C) comprises up to 60 wt. % of glass fibers and/or carbon fibers, for example from 30 to 40 wt. %, based on the total weight of the composition (C).

Preferably, the composition (C) is manufactured by a method comprising mixing the PAS copolymer (P), the at least one filler and, optionally, said at least one additional additive.

Said method advantageously comprises mixing the PAS copolymer (P), the at least one filler and, optionally, said at least one additional additive by dry blending and/or melt compounding. Said method preferably comprises mixing the PAS copolymer (P), the at least one filler and, optionally, said at least one additional additive by melt compounding, notably in continuous or batch devices. Such devices are well known to those skilled in the art.

Examples of suitable continuous devices to melt compound the composition (C) are screw extruders. Preferably, melt compounding is carried out in a twin-screw extruder.

If the composition (C) comprises a fibrous reinforcing filler having a long physical shape (e.g. a long glass fiber), drawing extrusion molding may be used to prepare a reinforced composition.

Articles and Applications

The present invention also relates to an article, part or composite material, comprising the PAS copolymer (P) or the composition (C) as described above. The article, part or composite material of the present invention find several uses in automotive applications, electric and electronic applications, and consumer goods.

According to a preferred embodiment, the article, part or composite material of the invention is molded from the PAS copolymer (P) or the composition (C) according to the invention by various molding methods such as injection molding, extrusion molding, compression molding, blow molding, and injection compression molding, preferably by injection molding and extrusion molding.

Furthermore, the article, part or composite material of the invention can be molded by a process of extrusion molding requiring a relatively high molding temperature and a long melt residence time, thanks to the flexibility, extremely high tensile elongation at break and high heat aging resistance of the PAS copolymer (P).

Examples of articles produced by extrusion molding include round bars, square bars, sheets, films, tubes, and pipes. Applications include electrical insulating materials for motors such as water heater motors, air-conditioner motors, and drive motors, film capacitors, speaker diaphragms, recording magnetic tapes, printed board materials, printed board peripherals, semiconductor packages, trays for conveying semiconductors, process/release films, protection films, film sensors for automobiles, insulating tapes for wire cables, insulating washers in lithium ion batteries, tubes for hot water, cooling water, and chemicals, fuel tubes for automobiles, pipes for hot water, pipes for chemicals in chemical plants, pipes for ultrapure water and ultrapure solvents, pipes for automobiles, pipes for chlorofluorocarbons and supercritical carbon dioxide refrigerants, and workpiece-holding rings for polishers. Other examples include molded articles for coating motor coil wires in hybrid vehicles, electric vehicles, railways, and power plants; and molded articles for coating heat-resistant electric wires and cables for household electrical appliances, wire harnesses and control wires such as flat cables used for the wiring in automobiles, and winding wires of signal transformers and car-mounted transformers for communication, transmission, high frequencies, audios, and measurements.

Applications of molded articles obtained by injection molding include electrical equipment components such as generators, electric motors, potential transformers, current transformers, voltage regulators, rectifiers, inverters, relays, power contacts, switches, breakers, knife switches, multipole rods, and electrical component cabinets; electronic components such as sensors, LED lamps, connectors, sockets, resistors, relay cases, small switches, coil bobbins, capacitors, variable capacitor cases, optical pickups, radiators, various terminal boards, transformers, plugs, printed circuit boards, tuners, speakers, microphones, headphones, small motors, magnetic head bases, power modules, semiconductors, liquid crystals, FDD carriages, FDD chassis, motor brush holders, parabolic antennas, and computer-related components; domestic and office electric appliance components such as VTR components, TV components, irons, hair dryers, rice cooker components, microwave oven components, acoustic components, audio equipment components for audios, laserdiscs (registered trademark), and compact discs, illumination components, refrigerator components, air conditioner components, typewriter components, and word processor components; machine-related components such as office computer-related components, telephone set-related components, facsimile-related components, copier-related components, cleaning jigs, motor components, lighters, and typewriters: components of optical and precision instruments such as microscopes, binoculars, cameras, and watches; automobile and vehicle-related components such as alternator terminals, alternator connectors, IC regulators, potentiometer bases for light dimmers, various valves including exhaust gas valves, various pipes for fuels, exhaust systems, and air intake systems, ducts, turboducts, air intake nozzle snorkels, intake manifolds, fuel pumps, engine coolant joints, carburetor main bodies, carburetor spacers, exhaust gas sensors, coolant sensors, oil temperature sensors, brake pad wear sensors, throttle position sensors, crankshaft position sensors, air flow meters, brake pad wear sensors, thermostat bases for air-conditioners, warming hot air flow control valves, brush holders for radiator motors, water pump impellers, turbine vanes, windshield wiper motor-related components, distributors, starter switches, starter relays, transmission wire harnesses, window washer nozzles, air-conditioner panel switch boards, coils for fuel solenoid valves, fuse connectors, horn terminals, electric component insulators, step motor rotors, lamp sockets, lamp reflectors, lamp housings, brake pistons, solenoid bobbins, engine oil filters, and ignition cases; and gaskets for primary batteries and secondary batteries in cellular phones, notebook computers, video cameras, hybrid vehicles, and electric vehicles.

In particular, the PAS copolymer (P) and the composition (C) according to the invention are suitable for manufacturing cable coatings, cable ties and metal pipe coatings. More in particular, the PAS copolymer (P) and the composition (C) according to the invention are suitable for making molded articles for coating motor coil wires in hybrid vehicles, electric vehicles, railways, and power plants; and various pipes for fuels, exhaust systems, and air intake systems and ducts, in particular, turboducts in automobiles, which are exposed to high-temperature environments.

According to an embodiment, the articles of the present invention are 3D printed from the PAS copolymer (P) or the composition (C) of the invention, by a process comprising a step of extrusion of the material, which is for example in the form of a filament, or by a process comprising a step of laser sintering of the material, which is in this case in the form of a powder.

The PAS copolymer (P) or the composition (C) can therefore be in the form of a thread or a filament to be used in a process of 3D printing, e.g. Fused Filament Fabrication, also known as Fused Deposition Modelling (FDM), or continuous fiber printing (CF), or in the form of a powder to be used in a process of 3D printing, e.g. Selective Laser Sintering (SLS) and Multi Jet Fusion (MJF). The part material to be printed may comprise additional components, which are specific to 3D printing, e.g. fiber tows for continuous carbon fiber additive manufacturing, or e.g. a flow agent for SLS type printing process.

Accordingly, the PAS copolymer or the composition (C) of the invention can be advantageously used for 3D printing applications.

The present invention also relates to a process for manufacturing a three-dimensional (3D) article, part or composite material, comprising:

a) depositing successive layers of a part material (M) comprising the PAS copolymer or the composition (C) described herein, and

b) printing layers prior to deposition of the subsequent layer.

If the PAS copolymer or the composition (C) is in the form of a powder, the process for manufacturing a 3D object may comprise selective sintering by means of an electromagnetic radiation of the powder.

If the PAS copolymer or the composition (C) is in the form of a filament, the process for manufacturing a 3D object may comprise the extrusion of the filament.

Should the disclosure of any patents, patent applications, and publications which are incorporated herein by reference conflict with the description of the present application to the extent that it may render a term unclear, the present description shall take precedence

The invention will now be described with reference to the following examples, whose purpose is merely illustrative and not intended to limit the scope of the invention.

### EXPERIMENTAL SECTION

Materials

Ryton® QA200N is a poly(phenylene sulfide) commercially available from Solvay Specialty Polymers USA, LLC.

Ryton® QA321N is a poly(phenylene sulfide) commercially available from Solvay Specialty Polymers USA, LLC.

DMS-E12 is an epoxypropoxypropyl terminated PDMS macromer (Mw 1,200 g/mol) commercially available from Gelest Inc. DMS-E12 will be referred to below as Ep-PDMS 1200.

DMS-E21 is an epoxypropoxypropyl terminated PDMS macromer (Mw 5,000 g/mol) commercially available from Gelest Inc. DMS-E21 will be referred to below as Ep-PDMS 5000.

Methods

DSC/Heat of Fusion

DSC analyses were carried out on a TA Q20 Differential Scanning calorimeter according to ASTM D3418 and data was collected through a two heat-one cool method. The protocol used is the following: 1^{st} heat cycle from 30.00° C. to 350.00° C. at 20.00° C./min; isothermal for 5 minutes; 1^{st} cool cycle from 350.00° C. to 100.00° C. at 20.00° C./min; 2^{nd} heat cycle from 100.00° C. to 350.00° C. at 20.00° C./min. The melting temperature (Tₘ) is recorded during the 2^{nd} heat cycle and the melt crystallization temperature (T_{mc}) is recorded during the cool cycle.

GPC

The weight-average molecular weight (Mw) of the poly(phenylene sulfide) copolymers was determined by gel permeation chromatography (GPC) at 210° C. using a PL 220 high temperature GPC with a 1-chloronaphtalene mobile phase.

Mechanical Testing

Test specimens according to Examples 1 to 3 (E1 to E3) and Comparative Examples 5 and 6 (CE5, CE6) were injection molded into Type V tensile bars according to ASTM D3641 (using a barrel temperature set at Tₘ+30° C. in a mold regulated at 130° C.) and tested at ambient temperature according to ASTM D638 at a speed of 0.05 in/min.

Test specimens according to Example 7 (E7) and Comparative Example 9 (CE9) were injection molded into ISO bars on a Toshiba ISG 150 Injection Molder and tested at ambient temperature according to ISO 527-2 at a speed of 1 mm/min.

The ISO bar of Example 7 (E7) was also subjected to fracture toughness testing according to ASTM 5045. Force and displacement, applied through a Zwick tensile strain machine at a speed of 1 mm/min, were recorded and toughness was evaluated according to ASTM 5045.

### Synthesis Examples

Poly(phenylene sulfide) copolymers according to Examples 1 to 3 (E1 to E3), Comparative Examples 4 to 6 (CE4 to CE6), Example 7 (E7) and Comparative Examples 8 to 10 (CE8 to CE10) were obtained from corresponding reactive blends containing a poly(phenylene sulfide) selected from Ryton® QA200N and Ryton® QA321N and an epoxypropoxypropyl terminated PDMS macromer selected from Ep-PDMS 1200 and Ep-PDMS 5000. Tables 1 and 2 below show the compositions of the reactive blends as well as the weight-average molecular weight (Mw) of the respective copolymers.

The reactive blends shown in Table 1 were made in a DSM Xplore Micro-compounder equipped with a Micro Injection Molding Machine 10 cc. The processing conditions used for making the blends are the following:

Recirculation time=15 minutes;

DSM speed=200 rpm;

Temperature=340° C.;

Target melt temperature=320° C.

TABLE 1

| | Ryton ® | Ryton ® | Ep-PDMS | Ep-PDMS | |
|---|---|---|---|---|---|
| | QA200N | QA321N | 1200 | 5000 | Mw |
| | [wt. %] | [wt. %] | [wt. %] | [wt. %] | [g/mol] |
| E1 | 99.4 | — | 0.6 | — | 62,600 |
| E2 | 98.4 | — | 1.6 | — | 61,800 |
| E3 | 97.5 | — | — | 2.5 | 74,800 |
| CE4 | 93.6 | — | — | 6.4 | 61,600 |
| CE5 | — | 98.8 | 1.2 | — | n/a |
| CE6 | — | 96.9 | 3.1 | — | n/a |

The reactive blends shown in Table 2 were made by blending the components in a Coperion ZSK-26 twin screw extruder, which is provided with 12 barrel zones and a heated exit die operating at up to 450° and is capable of mass throughputs higher than 30 kg/hour.

The components were initially mixed in a plastic bucket and sealed. The bucket was placed on a vibratory shaker for 2-3 minutes to assure homogeneity. The so obtained mixture was then placed in a K-TronT-35 gravimetric feeder and fed into the Coperion ZSK-26 twin screw extruder, melted, and mixed with screws designed to achieve a homogeneous melt composition. The melt stream was cooled and fed into a Maag Primo 60E pelletizer. The pellets were collected and kept in sealed plastic buckets until used for injection molding.

TABLE 2

| | Ryton ® | Ryton ® | Ep-PDMS | Ep-PDMS | |
|---|---|---|---|---|---|
| | QA200N | QA321N | 1200 | 5000 | Mw |
| | [wt. %] | [wt. %] | [wt. %] | [wt. %] | [g/mol] |
| E7 | 98.4 | — | 1.6 | — | 58,000 |
| CE8 | — | 98.4 | 1.6 | — | n/a |
| CE9 | 93.6 | — | — | 6.4 | 57,600 |
| CE10 | — | 93.6 | — | 6.4 | n/a |

Results

Table 3 shows the DSC values obtained for the poly(phenylene sulfides) copolymers according to the invention (E1-E3 and E7) in comparison to those of Ryton® QA200N.

TABLE 3

| | Tₘ (° C.) | ΔH (J · g⁻¹) |
|---|---|---|
| Ryton ® QA200N (Type V bar) | 285 | 42.0 |
| E1 (Type V bar) | 285 | 40.8 |
| E2 (Type V bar) | 284 | 37.6 |
| E3 (Type V bar) | 281 | 37.1 |
| Ryton ® QA200N (ISO bar) | 282 | 44.5 |
| E7 (ISO bar) | 283 | 42.7 |

The data reported in Table 3 show that the melting point (Tₘ) as well as the heat of fusion (ΔH) and, therefore, the degree of crystallinity, of the PDSM-modified poly(phenylene sulfides) according to the invention are substantially unaltered with respect to the unmodified poly(phenylene sulfides), namely Ryton® QA200N.

Table 4 reports the mechanical properties of the poly(phenylene sulfide) copolymers according Examples 1 to 3 (E1 to E3) in comparison to those of Ryton® QA200N and those of the poly(phenylene sulfide) copolymers according to Comparative Examples 4 to 6 (CE4 to CE6).

TABLE 4

| | Tensile stress at | Tensile | Modulus of |
|---|---|---|---|
| | break (MPa) | elongation (%) | elasticity (GPa) |
| Ryton ® QA200N | 92.4 | 4.9 | 3.77 |
| (Type V bar) | | | |
| E1 (Type V bar) | 84.8 | 7.7 | 3.83 |
| E2 (Type V bar) | 81.4 | 7.2 | 3.81 |
| E3 (Type V bar) | 75.2 | 8.9 | 3.61 |
| CE4 | — | — | — |
| CE5 (Type V bar) | 57.6 | 1.5 | 4.49 |
| CE6 (Type V bar) | 44.5 | 1.2 | 4.21 |

The data reported in Table 4 show that the bars according to E1 to E3 have a significantly higher tensile elongation than Ryton® QA200N, which means that the PDMS-modified poly(phenylene sulfides) of E1 to E3 have a higher elongation at break and a higher impact resistance than the unmodified poly(phenylene sulfide). Therefore, the PDMS-modified poly(phenylene sulfides) of the present invention are more ductile and tougher than Ryton® QA200N.

The improvement in ductility and toughness goes without significantly altering the tensile stress at break. Interestingly the modulus of elasticity of the bars according to E1 and E2 is slightly improved.

The data reported in Table 4 also demonstrate that the copolymers according the invention (E1 to E3) show a significantly improved set of mechanical properties than the copolymers according to the comparative examples (CE4 to CE6). In particular, the bars according to E1 to E3 have a much higher tensile elongation and a higher tensile stress at break than the bars according to CE5 and CE6, while exhibiting only a slightly lower modulus of elasticity. Tensile tests could not be performed on the copolymer of the comparative example CE4 because, due to its poor moldability, it could not be injection molded into tensile bars.

Table 5 reports the mechanical properties of the poly(phenylene sulfide) copolymer according Example 7 (E7) in comparison to those of Ryton® QA200N and those of the poly(phenylene sulfide) copolymers according to Comparative Examples 8 to 10 (CE8 to CE10).

TABLE 5

| | Tensile stress at | Tensile | Modulus of |
|---|---|---|---|
| | break (MPa) | elongation (%) | elasticity (GPa) |
| Ryton ® QA200N | 85.3 | 5.1 | 3.69 |
| (ISO bar) | | | |
| E7 (ISO bar) | 72.1 | 17 | 3.56 |
| CE8 | — | — | — |
| CE9 (ISO bar) | 65.5 | 6.1 | 3.27 |
| CE10 | — | — | — |

The data reported in Table 5 demonstrate that the bar according to E7 shows a significant increase in the elongation at break (higher than 300%) compared to Ryton® QA200N, while showing a very slight decrease in the modulus of elasticity and the tensile stress at break.

Furthermore, it is evident from the data of Table 5 that the bar according to E7 shows a notably higher elongation break and higher tensile stress at break and modulus of elasticity than the bar according to CE9.

Tensile tests could not be performed on the copolymers of the comparative examples CE8 and CE10 because they could not be injection molded into tensile bars, due to their poor moldability.

Therefore, as evident from Tables 4 and 5, the bars according to E1-E3 and E7 show a significantly improved balance between tensile stress at break, modulus of elasticity and tensile elongation, namely an improved balance between ductility, toughness and tensile strength. Said properties make the copolymer according to the invention suitable for different applications including injection molded articles, extrusion molded articles, 3D printed articles and thermoplastic composites.

Table 6 reports the fracture toughness results of the poly(phenylene sulfide) copolymer according Example 7 (E7) in comparison to those of Ryton® QA200N.

TABLE 6

| | | Displacement | Toughness |
|---|---|---|---|
| | F max (N) | max (mm) | (MPa · m^{1/2}) |
| Ryton ® QA200N | 154 | 0.8 | 3.88 |
| (ISO bar) | | | |
| E7 (ISO bar) | 170 | >3 | No break |

The data reported in Table 6 demonstrate that the bar according to E7 shows an increase of the maximal force and a huge improvement of the maximum displacement before break with respect to Ryton® QA200N. Furthermore, no break of the bar according to E7 was observed. Fracture toughness of the bar according to E7 was so high that it could not be measured with this methodology. Accordingly, only fracture toughness of Ryton® QA200N was measured.

1. A poly(arylene sulfide) (PAS) copolymer (P) comprising:
at least one block of poly(arylene sulfide) (PAS) having a weight-average molecular weight (Mw) of at least 40,000 g/mol as determined by gel permeation chromatography; and
at least one block of polyorganosiloxane (POS) having a weight-average molecular weight (Mw) of at most 5,000 g/mol as determined by gel permeation chromatography;
wherein the weight ratio of PAS:POS is from 95:5 to 99.5:0.5.

2. The PAS copolymer (P) of claim 1, comprising at least 1 ppm (wt) content of a polymer-bonded chlorine, based on the total weight of the PAS copolymer (P), as determined by means of X-ray Fluorescence (XRF) analysis calibrated with standards of known chlorine content as determined via Combustion and Ion Chromatography according to BS EN 14582.

3. The PAS copolymer (P) of claim 1, wherein the at least one block of PAS comprises at least 50 mol. % of a recurring PAS unit (R_{PAS}) according to formula (I), based on the total number of moles of recurring units in the block of PAS: 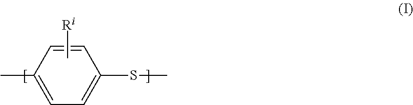
wherein R is independently selected from the group consisting of halogen atoms, C1-C12 alkyl groups, C7-C24 alkylaryl groups, C7-C24 aralkyl groups, C6-C24 arylene groups, C1-C12 alkoxy groups, and C6-C18 aryloxy groups, and i is independently zero or an integer from 1 to 4.

4. The PAS copolymer (P) of claim 1, wherein the at least one block of the PAS has a calcium content of less than 200 ppm, as measured by X-ray Fluorescence (XRF) analysis calibrated with standards of known calcium content as determined via ICP-OES according to ASTM UOP714-07.

5. The PAS copolymer (P) of claim 1, wherein the at least one block of POS is according to formula (II): 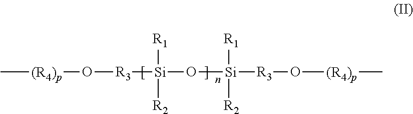
wherein:
R₁, R₂ and R₃ and R₄, equal to or different from each other, are selected from C₁-C₁₀ alkyl groups and C₆-C₁₀ aromatic groups;
n varies between 2 and 70; and
p is zero or 1.

6. The PAS copolymer (P) of claim 1, wherein R₁ and R₂ are methyl groups, R₃ is a propylene group, p is 1 and R₄ is a methylene group.

7. The PAS copolymer (P) of claim 1, wherein the weight-average molecular weight (Mw) of the PAS copolymer (P) ranges from 40,000 g/mol to 120,000 g/mol.

8. The PAS copolymer (P) of claim 1, wherein the melting point (Tₘ) of the PAS copolymer (P) is of at least 230° C., when determined on the 2^{nd} heat scan in differential scanning calorimeter (DSC) according to ASTM D3418, using heating and cooling rates of 20° C./min.

9. The PAS copolymer (P) of claim 1, wherein the glass transition temperature (T_{g}) of the PAS copolymer (P) is of at least 50° C., when determined on the 2^{nd} heat scan in differential scanning calorimeter (DSC) according to ASTM D3418, using heating and cooling rates of 20° C./min.

10. A process for preparing a poly(arylene sulfide) (PAS) copolymer (P) comprising blending at a temperature of at least Tₘ+10° C. a reaction mixture comprising:
at least one poly(arylene sulfide) (PAS) polymer having a weight-average molecular weight (Mw) of at least 40,000 g/mol as determined by gel permeation chromatography; and
at least one polyorganosiloxane (POS) macromer having epoxy groups at each end of its chain and having a weight-average molecular weight (Mw) of at most 5,000 g/mol as determined by gel permeation chromatography,
wherein:
Tₘ is the melting point of the reaction mixture;
the weight ratio between the PAS polymer and the POS macromer is from 95:5 to 99.5:0.5; and
the process is carried out in the absence of an added solvent or in the presence of an amount of less than 2 wt. % of the added solvent based on the total weight of the reaction mixture.

11. The process of claim 10, wherein the PAS polymer comprises at least one functional group at at least one of its chain ends and the functional groups are according to formula (IV): 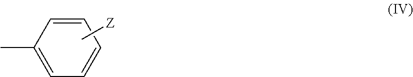
wherein Z is selected from the group consisting of halogen atoms, carboxyl group, amino group, hydroxyl group, thiol group, acid anhydride group, isocyanate group, amide group, and derivatives thereof.

12. The process of claim 10, wherein the POS macromer is according to formula (VI): 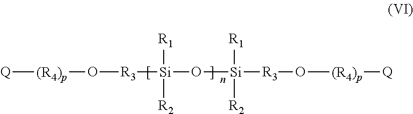
wherein:
Q is an epoxy group;
R₁, R₂ and R₃ and R₄, equal to or different from each other, are selected from C₁-C₁₀ alkyl groups and C₆-C₁₀ aromatic groups;
n varies between 2 and 70; and
p is zero or 1.

13. A composition (C) comprising:
the poly(arylene sulfide) (PAS) copolymer (P) of claim 1; and
up to 60 wt. % of at least one filler, based on the total weight of the composition (C).

14. An article, part or composite material comprising the poly(arylene sulfide) (PAS) copolymer (P) of claim 1 or a composition (C) comprising the poly(arylene sulfide) (PAS) and up to 60 wt % of at least one filler.

15. A method of manufacturing a three-dimensional (3D) object comprising:
depositing the poly(arylene sulfide) (PAS) copolymer (P) of claim 1 or a composition (C) comprising the poly(arylene sulfide) (PAS) and up to 60 wt % of at least one filler via additive manufacturing.
